(19) United States
(12) Patent Application Publication
(10) Pub. No.: US 2006/0097882 A1
(43) Pub. Date: May 11, 2006

(54) Apparatus, method, and system for tracking a wounded animal

(76) Inventors: Owen Brinkerhoff, Ogden, UT (US); Linda Brinkerhoff, Ogden, UT (US); Douglas Vause, Farr West, UT (US)

Correspondence Address: STEVEN MCDANIEL, MSEE;REG. PATENT AGENT, 846 S. 1350 E., PROVO, UT, 84606, US

(21) Appl. No.: 10/970,127

(22) Filed: Oct. 21, 2004

(51) Int. Cl. G08B 23/00; G01S 5/00; G08B 1/08; H04B 7/10; H04B 7/00; G01S 1/08

(52) U.S. Cl. 340/573.2; 340/539.13; 342/357.07; 342/361; 342/367; 342/386

(57) ABSTRACT

The apparatus, method, and system of the present invention provide an electronic tracking system for tracking a wounded animal. In one embodiment, a tracking element associated with an animal piercing projectile may be deposited on an animal. A tracking apparatus configured to track the position of the tracking element may comprise a positioning module, a tracking module, a display module, an orientation module, a communication module, and a coordination module. The tracking apparatus may display a visual representation of the position of the tracking element as well as other relative tracking information on a visual display. In one embodiment, the tracking apparatus displays the tracking element position on a visual map having topographical information thereon.

### BACKGROUND OF THE INVENTION

1. Field of the Invention

The present invention relates to electronic tracking systems. Specifically, the invention relates to apparatus, methods, and systems for electronically tracking a wounded animal.

2. Description of the Related Art

Game hunting is a common sport enjoyed by both young and old. Many hunters enjoy hunting with bows and arrows, while others prefer using firearms. Regardless of the chosen weapon, however, hunters typically experience a similar problem. Often, wounded animals, after being shot, bolt away from the hunters and bound up steep terrain, fleeing from the hunters' view. The hunters, seeking a trophy, must track the animal over hills and down gullies in order to claim their prize animal.

Tracking the wounded animal can be a difficult ordeal, and in certain instances, is nearly impossible. Without assistance from some kind of tracking device, the hunters have no way of knowing in which direction to search for the animal. In addition, the hunters are often thwarted by treacherous terrain. The wounded animal can typically escape over a mountain summit and die in a dense thicket, undiscovered by the hunters. The hunters consequently lose their trophy animal, and the animal's life is unduly lost.

One solution available to track wounded animals is to combine a radio transmitter device with an arrow. The arrow is then tracked by a directional radio receiver. This solution, unfortunately, has many limitations. First of all, once the animal is shot by an arrow with a transmitter, the ability to track the animal is based solely on directional information produced by the radio receiver. If the hunters are indeed following the animal in the correct direction, a cliff and a river may separate the hunters from the animal and the transmitter. Additionally, if the wounded animal is still roaming the area, the direction of the transmitted signal constantly changes, which may confuse the hunters. Also, the hunters have no way of knowing the distance the animal has traveled or the animal's speed. The unknowing hunters may be pursuing a hopeless venture.

Other solutions to track wounded animals combine arrows with audible devices. The audible devices can be useful to track animals within a very short range, but the hunters still face some of the problems mentioned above. Sound is the only indictor the hunters have to track the direction of the animal and the animal's state of well-being. Also, if the animal leaves the hunters' range of hearing, the hunters can no longer follow the tracking device. Also, the sound indicates a general area to investigate, but the hunters can still have trouble actually locating the wounded animal.

Furthermore, the hunters risk being separated from each other. For example, hunters may separate into groups in order to draw an animal out into an open area where one group of hunters can easily shoot the animal. If the hunters do not know exactly where the other hunters are located, the hunters may end up shooting at each other. Also, the hunters may have difficulty reuniting. Often, hunters spend a considerable portion of their time looking for other hunters in their party.

Given the aforementioned issues and challenges related to tracking a wounded animal and the shortcomings of currently available solutions, a need exists for an apparatus, method, and system for tracking a wounded animal with an improved electronic tracking system. Beneficially, such an apparatus, method, and system would track the position of a wounded animal relative to a known reference point such as the hunters current location. The apparatus, method, and system would further include information pertinent to the relative geographic area and would include a display module to visually display tracking information to a user such as topographical information.

### SUMMARY OF THE INVENTION

The present invention has been developed in response to the present state of the art, and in particular, in response to the problems and needs in the art that have not yet been fully solved by currently available electronic tracking systems to track wounded animals. Accordingly, the present invention has been developed to provide an apparatus, method, and system for tracking a wounded animal that overcome many or all of the above-discussed shortcomings in the art.

In one aspect of the present invention, an apparatus for tracking a wounded animal includes a positioning module, a tracking module, a display module, and an orientation module. The positioning module determines positioning information. In one embodiment, the positioning module comprises a GPS (Global Positioning System) receiver that determines a global position. Alternatively, the positioning module may determine a relative position such as the distance and direction to a tracking element attached to the animal.

The tracking module tracks the position of a tracking element. In one embodiment, the tracking element is deposited on an animal by an animal piercing projectile. The orientation module constructs a visual representation indicating the current position of a tracking apparatus relative to the tracking element position. The visual representation may then be displayed by the display module. In certain embodiments, the visual representation may comprise a visual map that includes topographical information.

In certain embodiments, the tracking apparatus coordinates activities with other tracking apparatus. The apparatus may include a coordination module that facilitates conducting coordination activities. In certain embodiments, the coordination activities may improve the accuracy of tracking information and positioning information and increase the range over which such information may be collected. Tracking information consequently may be exchanged among multiple tracking apparatus. The coordination activities may comprise identifying a projectile of interest and establishing one or more relative reference points.

In a further embodiment, the apparatus functions in conjunction with an animal piercing projectile. The tracking apparatus may include a projectile head configured to pierce an animal, a positioning module, an identification element associated with a unique identifier, and a signal emitter that communicates the unique identifier and positioning information to a tracking apparatus.

In yet another embodiment, the apparatus monitors the vital statistics of a wounded animal. The apparatus may include a projectile head, a positioning module, a monitoring module, and a signal emitter to communicate the vital statistics and positioning information to a tracking apparatus.

In another aspect of the present invention, a method for tracking a wounded animal includes determining a current global position of a tracking apparatus and tracking a tracking element. A visual map may then be displayed indicating the current global position and the tracking element position. Topographical information may also be displayed on the visual map. In addition, coordination activities may be conducted with another tracking apparatus or with a trackable projectile. In a further embodiment, the method includes piercing an animal with a projectile and depositing a tracking element. The tracking element may transmit a unique identifier and positioning information. Furthermore, the tracking element may communicate the vital statistics of a wounded animal.

Various elements of the present invention may be combined into a system arranged to carry out the functions or steps presented above. In one embodiment, the system includes a projectile configured to pierce an animal and deposit a tracking element and at least one tracking apparatus. The tracking apparatus may comprise a positioning module, a tracking module, a display module, a coordination module, and an orientation module.

The present invention facilitates tracking a wounded animal with an electronic tracking system. The position of a tracking element may be displayed relative to a determined position. In addition, coordination activities may be conducted to improve tracking capabilities. These and other features and advantages of the present invention will become more fully apparent from the following description and appended claims, or may be learned by the practice of the invention as set forth hereinafter.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a typical prior art positioning and mapping system;

FIG. 2 is a block diagram illustrating one embodiment of a coordinated tracking system in accordance with the present invention;

FIG. 3 is a block diagram illustrating one embodiment of a plurality of tracking devices in accordance with the present invention;

FIG. 4 is a flow chart diagram illustrating one embodiment of a tracking method in accordance with the present invention;

FIG. 5 is a flow chart diagram illustrating one embodiment of a tracking coordination method in accordance with the present invention; and

FIG. 6 is a front view illustration of one embodiment of a tracking interface in accordance with the present invention.

### DETAILED DESCRIPTION OF THE INVENTION

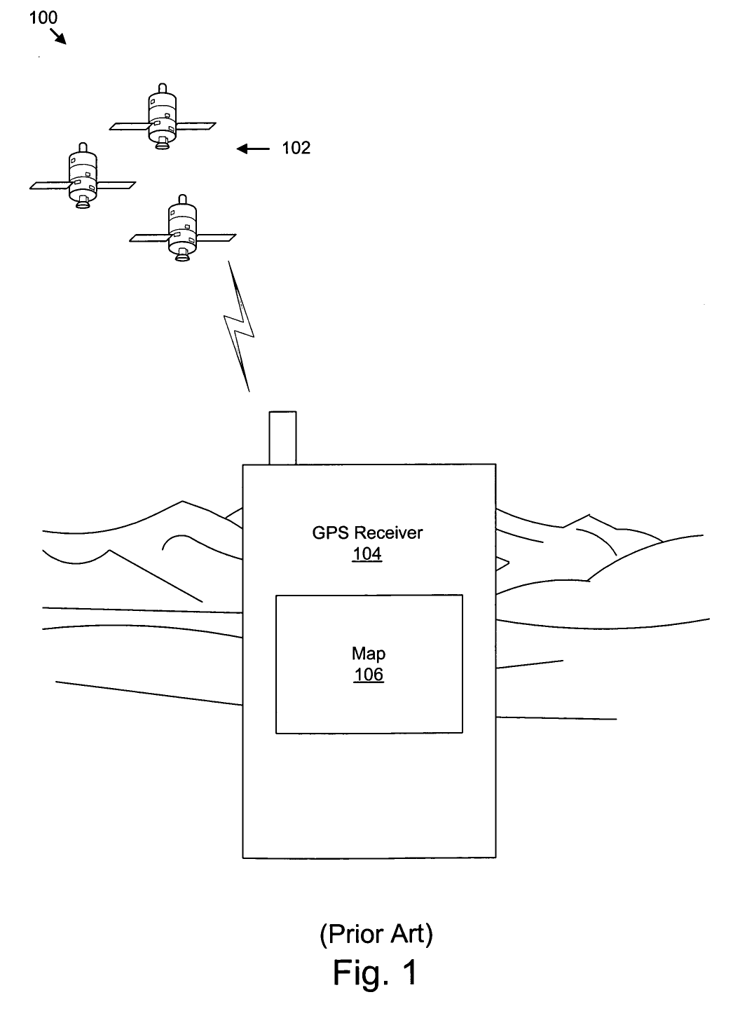

It will be readily understood that the components of the present invention, as generally described and illustrated in the figures herein, may be arranged and designed in a wide variety of different configurations. Thus, the following more detailed description of the embodiments of the apparatus, method, and system of the present invention, as represented in FIGS. 1 through 6, is not intended to limit the scope of the invention, as claimed, but is merely representative of selected embodiments of the invention.

Many of the functional units described in this specification have been labeled as modules, in order to more particularly emphasize their implementation independence. A module may be implemented via digital or analog circuits and components. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The features, structures, or characteristics of the invention described throughout this specification may be combined in any suitable manner in one or more embodiments. For example, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” or similar language throughout this specification do not necessarily all refer to the same embodiment and the described features, structures, or characteristics may be combined in any suitable manner in one or more embodiments.

The present invention sets forth an apparatus, system, and method for tracking a wounded animal. The position of a tracking element may be displayed on a tracking apparatus relative to a determined position. In addition, coordination activities may be conducted between multiple tracking devices to improve tracking capabilities.

FIG. 1 illustrates a typical prior art positioning and mapping system 100. The depicted system 100 is a Global Positioning System (GPS) and includes a constellation of satellites 102 and a GPS receiver 104. In one embodiment, the constellation of satellites 102 includes at least twenty-four strategically positioned satellites 102 orbiting the earth. The satellites 102 emit high-frequency, low-power radio signals that are received by the GPS receiver 104. The receiver 104 then determines a global position based on the signals received from the satellites 102. The global position typically includes the latitude, longitude, and altitude of the receiver 104.

The GPS receiver 104 may store geographic information in order to display the location of the receiver 104 on a local map 106. The GPS receiver 104 may also calculate and display additional statistical information relative to the receiver's location, such as distance traveled, travel time, speed, average speed, as well as a marked trail on the map 106 showing where the receiver 104 has traveled. The receiver 104 may also receive user input to calculate information such as an estimated time of arrival, or to determine a route of travel from one destination to another.

GPS receivers such as the GPS receiver 104 are often used to navigate vehicles, track people or vehicles, or give a location for emergency purposes, and the like. Outdoorsmen often use GPS receivers such as the depicted GPS receiver 104 to provide the user's current location on a display map with topographical information and other relative information. Consequently, the user may roam undeveloped areas with maps and directions available through the Global Positioning System 100.

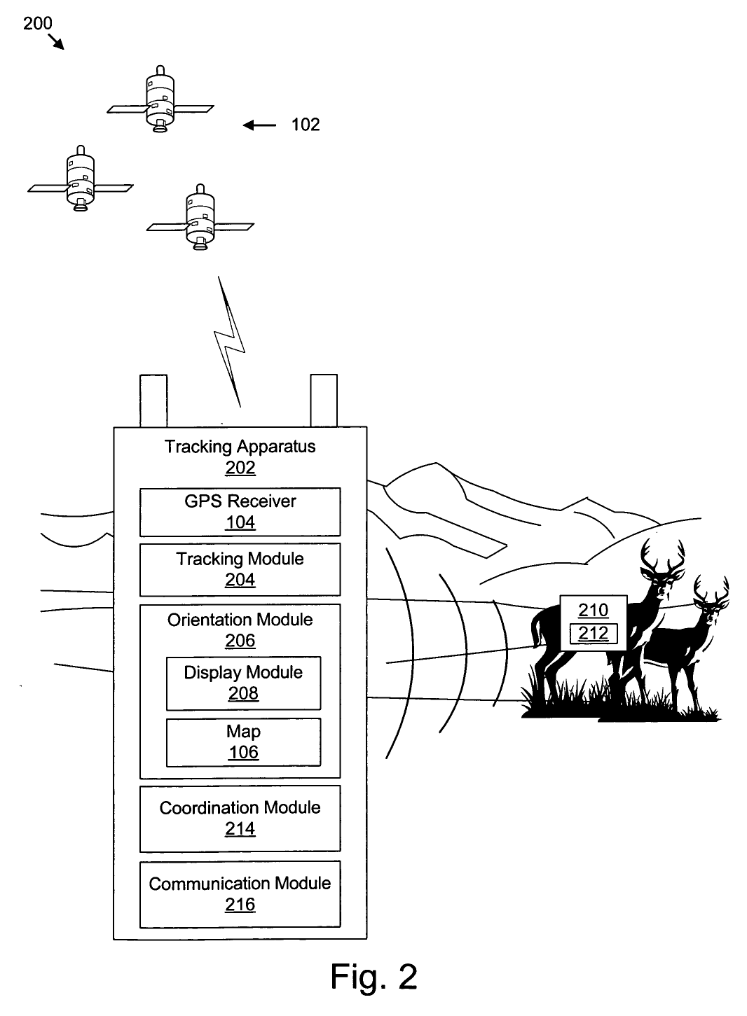

FIG. 2 illustrates one embodiment of a tracking system 200 in accordance with the present invention. The tracking system 200 may incorporate the elements discussed in relation to the mapping system 100 of FIG. 1 into a tracking unit 202. As depicted, the tracking unit 202 includes a positioning module 203, a tracking module 204, an orientation module 206 with a display module 208, a coordination module 214, and a communication module 216. Although depicted with a single tracking unit 202, the tracking system 200 may include multiple tracking units 202. The tracking system 200 may also include a projectile 210 equipped with a tracking element 212.

The positioning module 203 determines the current position of the tracking unit 202. In one embodiment, the positioning module is essentially the GPS receiver 104 depicted in FIG. 1, which receives radio signals from GPS satellites 102. The tracking unit 202 in one embodiment further comprises a projectile 210 configured to pierce an animal, such as an arrowhead, bullet, or the like, and deposit a tracking element 212. The tracking element 212 preferably transmits tracking information to the tracking module 204. Those of skill in the art will recognize that the tracking element 212 may comprise a variety of technologies suitable for providing tracking information to the tracking unit 202. Thus, the various embodiments described herein are not intended to limit the scope of the invention.

In one embodiment, the tracking element 212 comprises a Radio Frequency Identification (RFID) tag or chip. RFID chips, which function as miniature transponders, typically comprise a microprocessor and an antenna to receive and transmit radio signals. Subsequently, the RFID chips can be programmed with a unique identifier, similar to a bar code number, which can be tracked by corresponding equipment.

In such an embodiment, the tracking module 204 maybe configured to receive and transmit signals to the tracking element 212 in order to track the location of the tracking element 212. Furthermore, the tracking module 204 may track a plurality oft racking elements 212 simultaneously. In one embodiment, people, animals, objects, or other entities equipped with a tracking element 212 may also be tracked concurrently. For example, a tracking element 212 may be positioned at a known location to function as a reference point to facilitate tracking a wounded animal.

In certain embodiments, the tracking element 212 may also comprise a GPS receiver 104 that determines the global position of the tracking element 212. The tracking element 212 may then communicate the tracking element position to a tracking unit 202. In one embodiment, the tracking module 204 receives and tracks the global position of the tracking element 212.

In an alternative embodiment, the tracking element 212 may comprise traceable chemicals or other types of transmitters or transceivers, such as radio transmitters, cellular packets, or the like. Of course, the tracking element 212 may include a plurality of receivers, transmitters, transceivers, transponders, or the like. The tracking element 212 preferably functions without impeding the functionality of the animal piercing projectile 210.

The orientation module 206 may be configured to utilize the tracking and positioning information provided by the GPS receiver 104 and tracking module 204 to create a visual representation of the tracking element position relative to the current global position of the receiver 104. The visual representation may be displayed by a display module 208. A display module 208 may comprise any device capable of creating a visual display. In certain embodiments, the visual representation is displayed on a map 106. The map 106 may include topographical information and other relative geographical information.

The tracking unit 202 may also include a coordination module 214 and a communication module 216. The coordination module 214 may conduct coordination activities with another tracking unit 202 or tracking element 212. The coordination activities may enable the tracking unit 202 to provide more accurate tracking information. In certain embodiments, the coordination activities establish one or more reference points to facilitate tracking a wounded animal. In addition, tracking and positioning information may be exchanged to increase the range and accuracy of the tracking system.

The communication module 216 preferably enables a user to communicate with another entity. In one embodiment, the communication module 216 maybe configured to receive and transmit audio signals. Alternatively or in addition, the communication module 216 may be configured to communicate electronic messages. The communication module 216 accordingly provides the user the option to communicate with others if additional assistance is needed. In one embodiment, the communication module is configured to communicate with a database that provides the tracking unit 202 with geographical data pertinent to the users current location and/or needs.

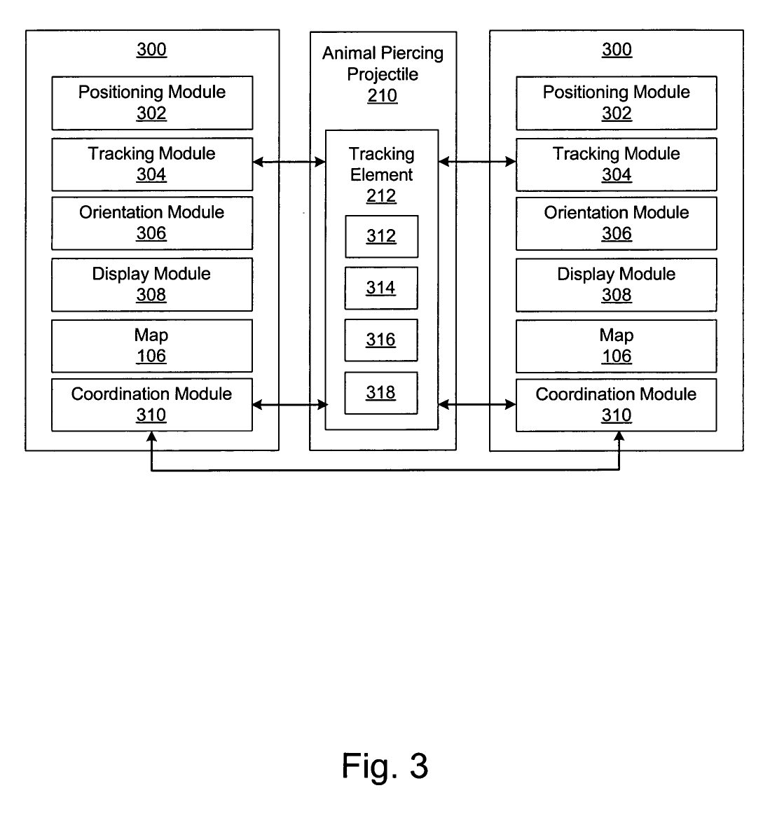

FIG. 3 illustrates an alternative embodiment of multiple devices 300 in communication with a tracking element 212 associated with an animal piercing projectile 210. The tracking device 300 includes, in one embodiment, a positioning module 302, a tracking module 304, an orientation module 306, a display module 308, a map 106, and a coordination module 310.

The positioning module 302 provides positioning information relative to the tracking device 300. In one embodiment, the positioning module 302 determines a current global position. Alternatively, the positioning module 302 may determine a position relative to one or more selected reference points. One of skill in the art will recognize that various technologies may be utilized to determine a relative position or an absolute position.

The tracking module 304 preferably communicates with the tracking element 212 to receive tracking information. As mentioned previously, the tracking element 212 may be associated with a wounded animal. The tracking information received by the tracking module 304, in one embodiment, includes the GPS coordinates of the tracking element 212. Alternatively, the tracking information may include a relative position.

The orientation module 306 constructs a visual representation based on the information received from the positioning module 302 and the tracking module 304. The display module 308 then displays to the user the tracking information as a visual image. In certain embodiments, the tracking information may be displayed on a map 106.

In select embodiments, the coordination module 310 performs coordination activities with another tracking device 300. Alternatively or in addition, the coordination module 310 may further conduct coordination activities with one or more tracking elements 212. In certain embodiments, the tracking element 212 is associated with a projectile 210. Input from multiple sources may improve tracking accuracy and global positioning accuracy. In certain embodiments, the position of the tracking element 212 may be a relative position, such as a certain distance from a known landmark or a tracking device 300. In an alternative embodiment, the tracking element position is an absolute position, such as a global position.

In certain embodiments, the tracking element 212 may include a plurality of components to facilitate tracking a wounded animal. In one embodiment, the tracking element 212 includes a positioning module 312, an identification element 314, a signal emitter 316, and a monitoring module 318.

The positioning module 312 preferably provides positioning information of the tracking element 212 to the tracking device 300. In one embodiment, the tracking element 212 is an accelerometer. The positioning module 302 then integrates acceleration information to determine the current position of the tracking element 212. Consequently, the distance between the tracking element 212 and a point of reference may be calculated. Alternatively or in addition, the positioning module 302 may comprise a global positioning circuit. Thus, the tracking device 300 may track the tracking element 212 using the global position system 100 illustrated in FIG. 1.

The tracking element 212 may further be associated with an identification element 314. The identification element 314, in one embodiment, comprises a unique identifier, such as a bar code or RFID code, that distinguishes the tracking element 212. As a result, a tracking device 300 may easily track a plurality of tracking elements 212. In addition, an identification element 314 associated with a tracking position allows the tracking element 212 to be easily displayed on a visual map 106. In certain embodiments, a signal emitter 316 communicates the position information as well as the unique identifier to a tracking device 300.

In certain embodiments, the identification element 314 comprises a trace element that is released when the projectile 212 impacts an object. In one embodiment, the trace element is released at a particular rate or at regular intervals in order to leave a trackable trail. Once released, the trace element and associated trail may then be tracked by a tracking device 300. In one embodiment, a trace element comprises a radioactive material traceable with a Geiger counter or the like. In another embodiment, the trace element is a chemical compound that has visually traceable characteristics, such as a smoke trail or brilliant colors. Alternatively, the trace element, or identification element 314, may be traceable by sight, sound or smell.

The tracking distance or relative position attainable by the present invention is dependent on the limits of the tracking element 212 and associated components. In one embodiment, a tracking element 212 using presently attainable RFID technology may be sensed by one or more tracking device 300 at over four miles in distance. In another embodiment involving a trace element, the tracking distance may be dependent on environmental circumstances, such as weather conditions. The number of tracking elements 212 that can be tracked simultaneously is also dependent upon the tracking device 300 and relevant technology and associated conditions.

In certain embodiments, the tracking element 212 may track the vital statistics of a wounded animal. In such an embodiment, the tracking element 212 may include a monitoring module 318 comprising sensors to monitor the vital signs of the animal. In certain embodiments, a thermo-sensitive element, such as a thermometer, may track the animal's temperature. In addition, a pressure-sensitive element may monitor the animal's heartbeat.

In one embodiment, the sensors include a microphone to capture sounds emitted by the heart and lungs of the animal as well as environmental sounds. Furthermore, in addition to capturing vital information, a microphone may also be used to track a sonar signal emitted by a tracking device 300. Consequently, tracking information relative to distance and speed may also be calculated (based on the Doppler Effect).

The schematic flow chart diagrams that follow are generally set forth as logical flow chart diagrams. As such, the depicted order and labeled steps are indicative of one embodiment of the presented method. Other steps, methods, and orderings may be conceived that are equivalent in function, logic, or effect to one or more steps, or portions thereof, of the illustrated method. Additionally, the format and symbology employed are provided to explain the logical steps of the method and are understood not to limit the scope of the method.

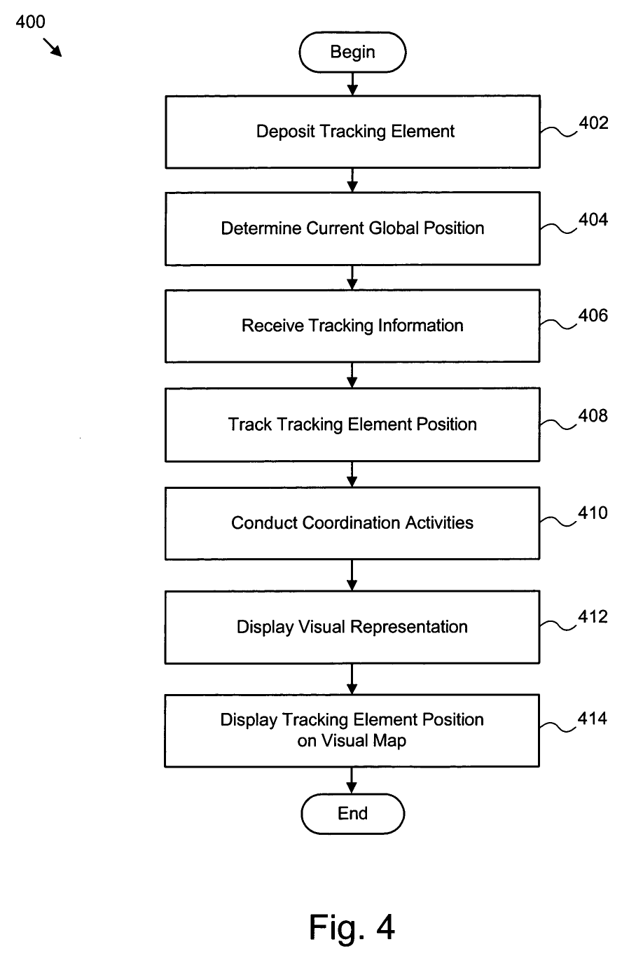

FIG. 4 is a flow chart diagram showing the various steps of a method 400 for tracking a wounded animal. The method 400 is, in certain embodiments, a method of use of the system and apparatus of FIG. 2 and FIG. 3, and will be discussed with reference to those figures. Nevertheless, the method 400 may also be conducted independently thereof and is not intended to be limited specifically to the specific embodiments discussed above with respect to those figures.

As shown in FIG. 4, the method 400 begins, and a tracking element 212 is deposited 402 on a target, such as an animal. In select embodiments, the tracking element is deposited by a projectile head configured to pierce an animal. In alternative embodiments, a tracking element 212 may be deposited on a person, object, or the like. The tracking element is preferably configured to transmit tracking information. In certain embodiments, a current global position is then determined 404.

Next, tracking information is received 406 and the tracking element position is tracked 408. In one embodiment, the tracking information is transmitted by a signal emitter 316 associated with the tracking element 212. The tracking information may comprise data such as global positioning, a unique identifier provided by an identification element, vital statistics provided by a monitoring module, acceleration, distance, direction, and the like. In one embodiment, the tracking information is received by the tracking module 304.

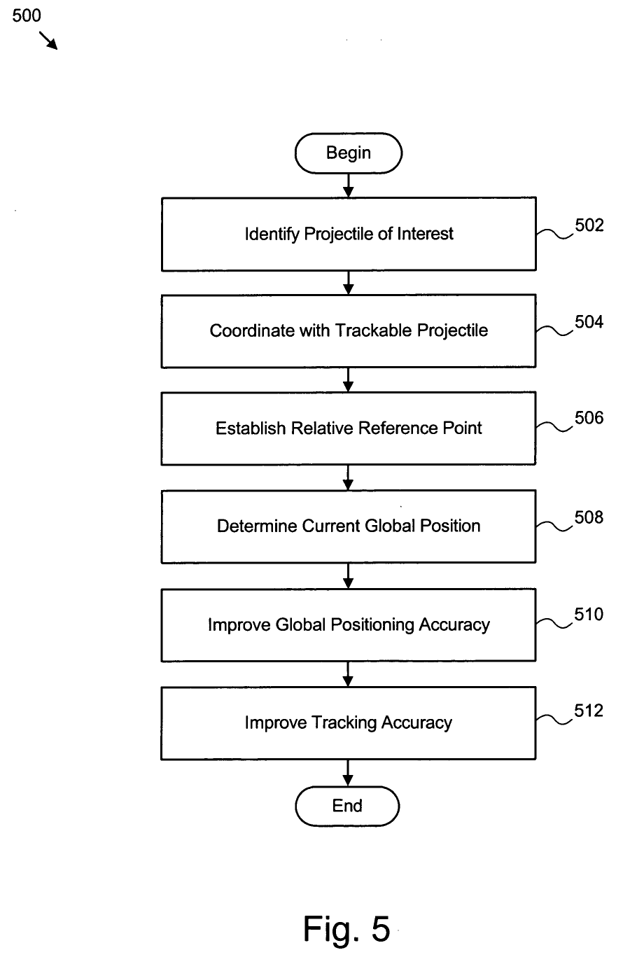

In certain embodiments, coordination activities are conducted 410. The coordination activities may include coordinating tracking information associated with a plurality of tracking apparatus. Conducting coordination activities will be discussed in greater detail in relation to FIG. 5.

Once tracking information is received and coordinated, a visual representation of the tracking information maybe displayed 412. Furthermore, a visual map 106 illustrating a tracking element position may be displayed 414. Consequently, a tracking element 212, which may be deposited on a wounded animal, may be tracked on a visual map 106 revealing the position of the tracking element 212. In certain embodiments, the visual map 106 may include topographical information and other geographical information extracted from a database in order to further facilitate tracking the tracking element 212. The map 106 may also include additional local information as well as the position of the user. Thus, the user may view the position of the tracking element 212 relative to the position of tracking device 300 or to known landmarks, such as roads, trails, rivers, etc. Subsequently, the method 400 ends 416.

FIG. 5 is a flow chart diagram showing the various steps of a method 500 for conducting coordination activities. The method begins by identifying 502 a projectile of interest and coordinating 504 with a trackable projectile 210. In one embodiment, identifying 502 a projectile 210 of interest may comprise selecting a projectile 210 associated with a tracking element 212. The tracking element 212 may comprise a unique identifier, such as a bar code or RF identifier (RFID). The identifier may then be registered to be tracked by a tracking device 300. In one embodiment, the projectile 210 of interest is identified, or registered, by scanning a unique code in close proximity. In another embodiment, the identifier is registered by manually entering a code printed on the projectile 210.

Coordinating 504 with a trackable projectile 210 may comprise initiating the tracking device 300 in one embodiment. One or more relative reference points may then be established 506. In one embodiment, a reference point comprises a starting position, which allows the tracking device 300 to determine relative tracking information. A current global position may also be determined 508 to further augment the tracking information. The global position may then be compared to other tracking information known or received. The tracking information may also be exchanged 509 with other tracking devices 300. Thus, the information received by coordinating activities may be used to improve 510 global positioning accuracy as well as to improve 512 tracking accuracy. Exchanging information also enables the electronic tracking system to cover a greater range of area. Consequently, by utilizing coordination activities to obtain more accurate tracking information, one or more users can effectively track a wounded animal. Then the method 500 ends 514.

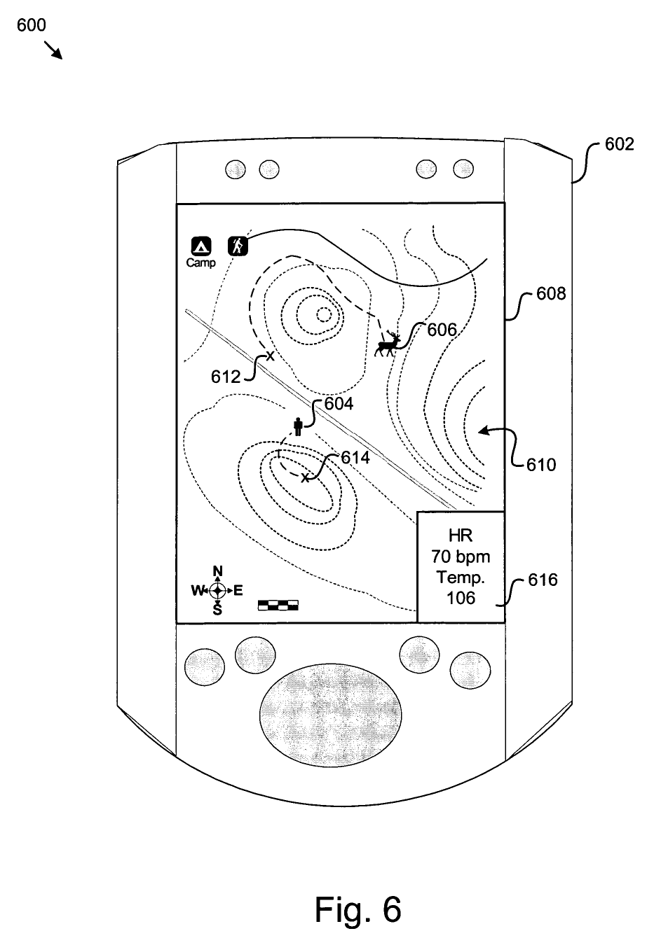

FIG. 6 illustrates one embodiment of a tracking apparatus 600 in accordance with the present invention. The tracking apparatus 600, in one embodiment, may be incorporated into a portable electronic device 602, such as a laptop computer, a pocket computer, a cellular phone, a hand-held GPS receiver, an electronic organizer, or the like. The positioning module 302 of the tracking apparatus 600 preferably determines a current global position. The orientation module 306 may then use the global position and tracking information received from a tracking element 212 to create a visual representation of a user location 604 relative to a tracking element position 606. The relative locations 604, 606 may then be displayed on a display screen 608.

In certain embodiments, the visual representation includes a map 610 with local topographical information. Thus, the user may determine where he/she is located relative to the wounded animal and the local terrain. In addition, the coordination module 310 may establish a starting position 612 to track the tracking element 212. A tracking device 300 starting position 614 may also be established. Consequently, the user may determine the path of the wounded animal and the best way to track and locate the animal.

For example, a hunter standing on top of a hill may shoot a deer in a valley by a river, depositing a tracking element 212 on the wounded animal. In certain embodiments, the coordination module 310 may automatically determine the starting position 612 of the tracking element based on the information transmitted to the tracking module 304 from the tracking element 212 as discussed above. The deer may then dash away heading northwest and disappear into a heavily wooded area. Based on traditional approaches, the hunter may head northwest to follow the animal into the wooded area.

With the tracking apparatus 600, however, the path of the wounded animal is clearly revealed. If the hunter continues heading northwest, the hunter will be moving in the opposite direction of the wounded animal. Plus, steep terrain will separate the hunter from the deer, complicating the path to reach the animal. The tracking information available with the tracking apparatus 600 enables the hunter to view an augmented topographical map 610 and make an informed decision on how to effectively navigate the local terrain and track the deer. Based on the local geographic information available, the hunter may decide not to cross the river, but to drive to a nearby road or bridge and track the animal from a different direction.

Additional graphic displays 616 may be available to communicate specific information relative to the tracking element 212. For example, one display 616 may contain vital statistic information monitored by the tracking element 212. Consequently, the physical state of the wounded animal may be monitored. For example, if an animal dies, the time of death may easily be determined. Alternatively, if a bear or predatory animal is extremely active, the user may wish to distance themselves from the animal. Additional displays 616 may contain relative information such as speed, GPS location, distance, suggested routes, local information, hunting tips, etc.

In certain embodiments, the tracking apparatus 600 may track a plurality of tracking elements 212 or tracking device 300. For instance, the location of several hunters and/or wounded animals associated with different tracking elements 212 may be displayed on a tracking apparatus 600. Consequently, a collaborated effort may be made to track the wounded animal(s). Alternatively, hunters may avoid hunting where the other hunters are located. In certain embodiments, tracking elements 212 may be strategically disposed in an area to mark reference points on a map 610. For example, a hunter may place a tracking element 212 on his/her truck to mark the vehicle on the map 610.

In one embodiment, the tracking apparatus 600 includes a communication module 216 (FIG. 2) to permit various users to communicate with each other, for example, by radio transmission, cellular phone, text messaging, etc. Thus, if the user wishes to call for assistance, the user may use the tracking apparatus 600 to contact outside sources. Alternatively, the user may receive information from other sources.

The improved apparatus, method, and system of the present invention allow a user to effectively track a wounded animal with an electronic tracking system. The invention provides tracking apparatus to determine the location of a tracking element and to display a tracking element position on a visual representation. Thus, the user can know with certainty where a wounded animal is located. Consequently, the user may intelligently plan the most effective manner to claim his/her trophy animal. Wounded animals no longer escape to die unnoticed. The hunter can successfully track the animal with modern technology.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for tracking a wounded animal, the apparatus comprising:
a positioning module configured to determine a current position;
a tracking module configured to track a tracking element position in conjunction with a tracking element depositable by an animal piercing projectile;
a display module configured to display a visual image; and
an orientation module configured to construct a visual representation that indicates the current position relative to the tracking element position.

2. The apparatus of claim 1, wherein the orientation module is further configured to construct a visual map having topographical information thereon.

3. The apparatus of claim 1, further comprising a coordination module configured to conduct coordination activities with another tracking apparatus.

4. The apparatus of claim 1, further comprising a communication module configured to enable a user to communicate with another entity.

5. An apparatus for tracking a wounded animal, the apparatus comprising:
a positioning module configured to determine a global position;
a tracking module configured to track a tracking element position in conjunction with a tracking element depositable by an animal piercing projectile;
a display module configured to display the tracking element position; and
a coordination module configured to conduct coordination activities with another tracking apparatus.

6. The apparatus of claim 5, wherein the coordination activities comprise improving tracking accuracy.

7. The apparatus of claim 5, wherein the coordination activities comprise improving global positioning accuracy.

8. The apparatus of claim 5, wherein the coordination activities comprise identifying a projectile of interest.

9. The apparatus of claim 5, wherein the coordination activities comprise establishing a relative point of reference.

10. The apparatus of claim 5, wherein the other tracking apparatus is a projectile.

11. The apparatus of claim 5, wherein the tracking element is associated with an animal piercing projectile.

12. The apparatus of claim 5, wherein the tracking element position is a relative position.

13. The apparatus of claim 5, wherein the tracking element position is an absolute position.

14. The apparatus of claim 5, further comprising an orientation module configured to construct a visual representation displayable by the display module.

15. The apparatus of claim 14, wherein the orientation module is further configured to construct a visual map having topographical information thereon.

16. An apparatus for tracking a wounded animal, the apparatus comprising:
a projectile head configured to pierce an animal;
a positioning module configured to provide positioning information;
an identification element configured to provide a unique identifier; and
a signal emitter configured to communicate the unique identifier and the positioning information to a tracking apparatus.

17. The apparatus of claim 16, wherein the positioning module comprises an accelerometer.

18. The apparatus of claim 16, wherein the positioning module comprises a global positioning circuit.

19. An apparatus for tracking a wounded animal, the apparatus comprising:
a projectile head configured to pierce an animal;
a positioning module configured to provide positioning information;
a monitoring module configured to monitor vital statistics of a wounded animal; and
a signal emitter configured to communicate vital statistics and positioning information to a tracking apparatus.

20. A method for tracking a wounded animal, the method comprising:
determining a current global position;
tracking a tracking element position; and
displaying a visual representation indicating the current global position relative to the tracking element position.

21. The method of claim 20, further comprising displaying topographical information on a visual map.

22. The method of claim 20, further comprising conducting coordination activities with another tracking apparatus.

23. A method for tracking a wounded animal, the method comprising:
determining a global position;
tracking a tracking element position;
displaying the tracking element position; and
conducting coordination activities with another tracking apparatus.

24. The method of claim 23, wherein conducting coordination activities comprises improving tracking accuracy.

25. The method of claim 23, wherein conducting coordination activities comprises improving global positioning accuracy.

26. The method of claim 23, wherein conducting coordination activities comprises identifying a projectile of interest.

27. The method of claim 23, wherein conducting coordination activities comprises establishing a relative point of reference.

28. The method of claim 23, wherein conducting coordination activities comprises coordination with a trackable projectile.

29. The method of claim 23, wherein the tracking element position is a relative position.

30. The method of claim 23, wherein the tracking element position is an absolute position.

31. The method of claim 23, further comprising displaying a visual representation.

32. The method of claim 23, wherein the visual representation includes a visual map having topographical information thereon.

33. A method for tracking a wounded animal, the method comprising:
piercing an animal with a projectile and depositing a tracking element; and
receiving a unique identifier and positioning information provided by the tracking element.

34. A method for tracking a wounded animal, the method comprising:
piercing an animal with a projectile and depositing a tracking element; and
receiving vital statistics and positioning information provided by the tracking element.

35. A system for tracking a wounded animal, the system comprising:
a projectile configured to pierce an animal and deposit a tracking element;
at least one tracking apparatus, each tracking apparatus thereof comprising:
a positioning module configured to determine a global position,
a tracking module configured to track a tracking element position in conjunction with the tracking element,
a display module further configured to display the tracking element position,
a coordination module configured to conduct coordination activities with another tracking apparatus, and
an orientation module configured to construct a visual map having terrain information thereon.

36. The system of claim 35, further comprising a database configured to provide geographical information to the at least one tracking apparatus.

37. A computer readable storage medium comprising computer readable program code configured to carry out a method for tracking a wounded animal, the method comprising:
determining a global position;
tracking a tracking element position;
displaying the tracking element position; and
conducting coordination activities with another tracking apparatus.
